(19) United States
(12) Patent Application Publication
(10) Pub. No.: US 2025/0212174 A1
(43) Pub. Date: Jun. 26, 2025

(54) METHODS, COMMUNICATIONS DEVICES, AND INFRASTRUCTURE EQUIPMENT

(71) Applicant: Sony Group Corporation, Tokyo (JP)

(72) Inventors: Yassin Aden AWAD, Basingstoke (GB); Vivek SHARMA, Basingstoke (GB); Yuxin WEI, Basingstoke (GB); Hideji WAKABAYASHI, Basingstoke (GB)

(73) Assignee: Sony Group Corporation, Tokyo (JP)

(21) Appl. No.: 18/848,144

(22) PCT Filed: Mar. 3, 2023
(86) PCT No.: PCT/EP2023/055494

§ 371 Date: Sep. 18, 2024

(30) Foreign Application Priority Data
Mar. 28, 2022 (EP) 22164839.7

(51) Int. Cl. H04W 68/00; H04W 56/00; H04W 72/115; H04W 74/0833

(52) U.S. Cl. CPC H04W 68/00; H04W 56/0045; H04W 72/115; H04W 74/0833

(57) ABSTRACT

A method for operating a communications device in a wireless network is described. While in an inactive state, the device receives a paging message indicating an upcoming downlink small data transmission (SDT). Upon receiving the message, the device determines if predetermined conditions for receiving the SDT are met. It then transmits an indication to the network regarding whether the conditions are met and receives the downlink SDT based on this determination.

### BACKGROUND

### Field of Disclosure

The present disclosure relates to communications devices, infrastructure equipment and methods for the efficient reception of data by a communications device in a wireless communications network.

The present application claims the Paris Convention priority from European patent application number EP22164839.7, filed on 28 Mar. 2022, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device configured to transmit signals to and/or to receive signals from a wireless communications network via a wireless radio interface provided by the wireless communications network. The method comprises, while the communications device is operating in an inactive state, receiving, from the wireless communications network, a paging message, the paging message indicating that the wireless communications network is to transmit, to the communications device, a downlink small data transmission. SDT, determining, in response to receiving the paging message, whether or not one or more predetermined conditions for reception of the downlink SDT are met, transmitting, to the wireless communications network, an indication of whether or not the one or more predetermined conditions are met, and receiving the downlink SDT from the wireless communications network in a manner dependent on whether or not the one or more predetermined conditions are met.

Embodiments of the present technique, which, in addition to methods of operating communications devices, relate to communications devices, infrastructure equipment, methods for operating such infrastructure equipment, circuitry for such communications devices and infrastructure equipment, wireless communications systems, computer programs, and non-transitory computer-readable storage mediums, allow for more efficient use of radio resources by a communications device.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIGS. 4A and 4B illustrate how uplink small data transmissions (SDT) may be performed by a user equipment (UE) using random access (RACH) schemes while the UE is in an inactive state;

FIG. 5 shows a part schematic, part message flow diagram representation of a wireless communications system comprising a communications device and an infrastructure equipment in accordance with embodiments of the present technique;

FIG. 6 shows a flow diagram illustrating a first example process of communications in a communications system in accordance with embodiments of the present technique; and

FIG. 7 shows a flow diagram illustrating a second example process of communications in a communications system in accordance with embodiments of the present technique.

### DETAILED DESCRIPTION OF THE EMBODIMENTS

### Long Term Evolution Advanced Radio Access Technology (4G)

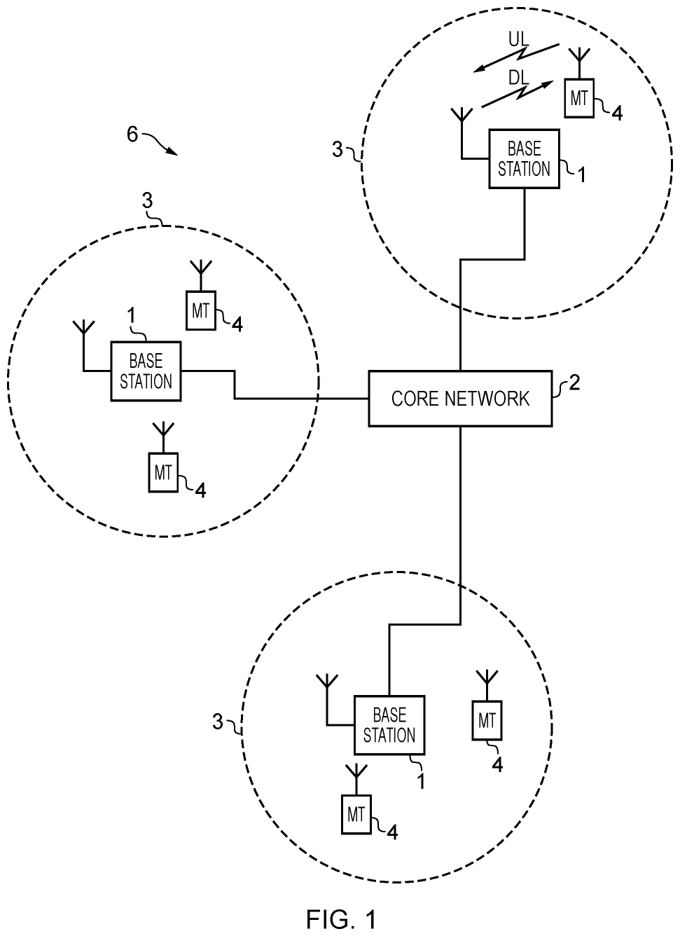

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example. Holma H, and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL. Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

3GPP has completed the basic version of 5G in Rel-15, known as the New Radio Access Technology (NR). In addition, enhancements have been made in Rel-16, incorporating new features such as the 2-step RACH procedure [2]. Industrial Internet of Things (IIoT) [3] and NR-based Access to Unlicensed Spectrum (NR-U) [4].

Further enhancements have been agreed for Rel-17, such as small data transmissions (SDT) in the uplink while the transmitting UE is in the RRC_INACTIVE state, as well as Multicast and Broadcast Services (MBS) and positioning enhancements. With reference to [5], some specific examples of mobile originated small data transmission (MO SDT) and infrequent data traffic may include the following use cases:
Smartphone applications:
   Traffic from Instant Messaging services;
   Heart-beat/keep-alive traffic from IM/email clients and other applications; and
   Push notifications from various applications;
Non-smartphone applications:
   Traffic from wearable devices (e.g, periodic positioning information);
   Sensors (e.g., Industrial Wireless Sensor Networks transmitting temperature or pressure readings, periodically or in an event-triggered manner); and
   Smart meters and smart meter networks sending periodic meter readings.

In addition, based on [5] as mentioned above, uplink small data transmissions have been enabled for UEs in the RRC_INACTIVE state (i.e. without the UE moving to a fully connected state with the network) in order to reduce the signalling overheads as well as power consumption at the UE, and primarily being for infrequent data traffic. SDT transmission on the uplink for UEs in the RRC_INACTIVE state has been agreed for both RACH based schemes (i.e. 2-step and 4-step RACH)—known as Random Access SDT (RA-SDT)—and configured grant (CG) based schemes (CG-SDT), each of which is discussed in greater detail below. This includes general procedures to enable user plane data transmissions for small data packets on the uplink in the inactive state (for example using either MsgA of the 2-step RACH procedure or Msg3 of the 4-step RACH procedure), and enables flexible payload sizes larger than the Rel-16 Common Control Channel (CCCH) message size that is possible currently for a UE in the RRC_INACTIVE state to transmit small data in MsgA or Msg3 to support user plane data transmission in the uplink.

While the supporting of SDT in the uplink (i.e. MO SDT) is still under development in Rel-17 (e.g, see [5]), discussions have also begun for the need for mobile terminated (MT) transmissions in the downlink for SDT in Rel-18 [6], for example to use for positioning services or infrequent small data reception at UEs in the RRC_INACTIVE state. With reference to [6], the following justifications and objectives for MT SDT in Rel-18 are established:
Justification-Rel-17 specified MO-SDT to allow small packet transmission for UL-oriented packets. For the DL. MT-SDT (i.e. DL-triggered small data) allows similar benefits, in reducing signalling overhead and UE power consumption by not transitioning to RRC_CONNECTED and reducing latency by allowing fast transmission of (small and infrequent) packets, e.g, for positioning; and
Objectives:
   specification of the support for paging-triggered SDT (MT-SDT);
   MT-SDT triggering mechanism for UEs in RRC_INACTIVE, supporting RA-SDT and CG-SDT as the UL response; and
   MT-SDT procedure for initial DL data reception and subsequent UL/DL data transmissions in RRC_INACTIVE.

### Example NR Configuration

The NR radio access system employs Orthogonal Frequency Division Multiple Access (OFDMA), where different users are scheduled in different subsets of sub-carriers simultaneously. However. OFDMA requires tight synchronisation in the uplink transmissions in order to achieve orthogonality of transmissions from different users. In essence, the uplink transmissions from all users must arrive at the same time (i.e. they must be synchronised) at the gNB receiver. A UE that is far from the gNB must therefore transmit earlier than a UE closer to the gNB, due to different RF propagation delays. In NR, timing advance commands are applied to control the uplink transmission timing for individual UEs, mainly for Physical Uplink Shared Channels (PUSCHs). Physical Uplink Control Channels (PUCCHs) and Sounding Reference Signals (SRS). The timing advance usually comprises twice the one-way propagation delay between the UE and gNB, thus representing both downlink and uplink delays.

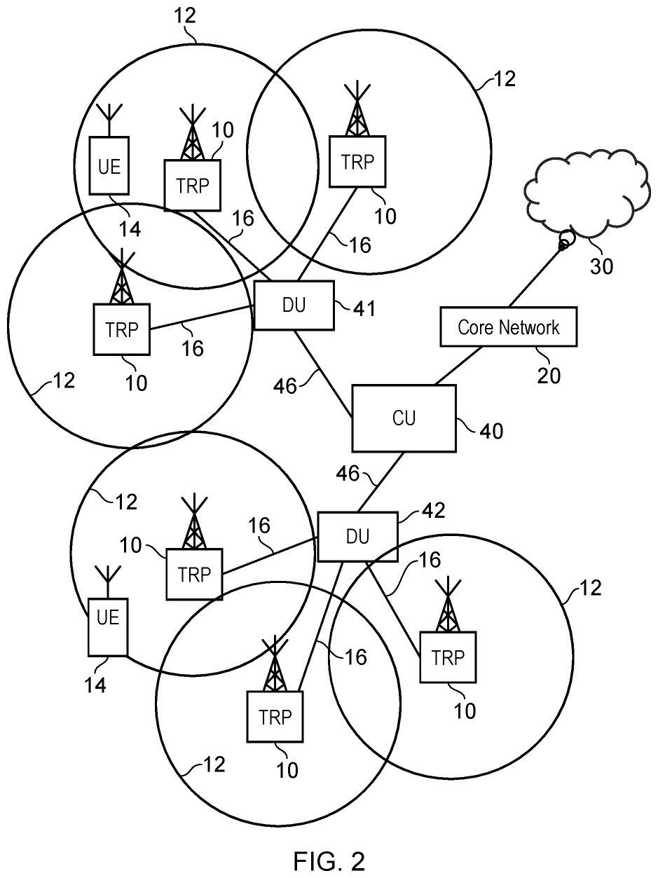

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface (i.e. a radio interface for wireless access) within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g, in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

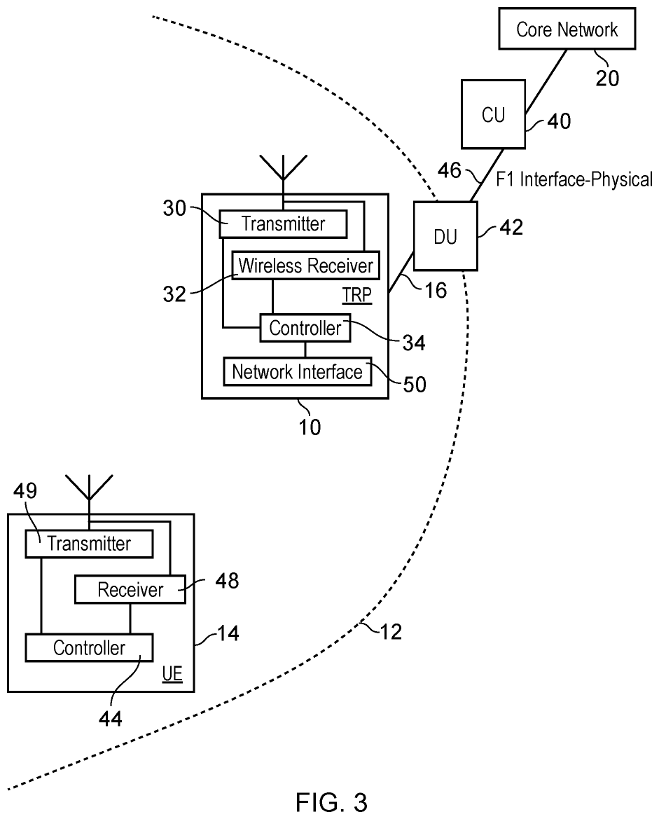

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 45, a receiver 48 and a controller 44 which is configured to control the transmitter 45 and the receiver 48 to transmit signals representing uplink (UL) data to the wireless communications network via the wireless access interface formed by the TRP 10 and to receive downlink (DL) data as signals transmitted by the transmitter 30 and received by the receiver 48 in accordance with the conventional operation.

The transmitters 30, 45 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for case of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 47 which connects to the DU 42 via a physical interface 16. The network interface 47 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 47 of the TRP10 to the DU 42 and the F1 interface 46 from the DU 42 to the CU 40.

### Mobile Originated Small Data Transmission (MO SDT)

As described, there are three schemes agreed by 3GPP for the initiation of SDT transmissions on the uplink, originating from a mobile UE in the inactive state. These are:
4-step RACH based scheme;
2-step RACH based scheme; and
CG based scheme.

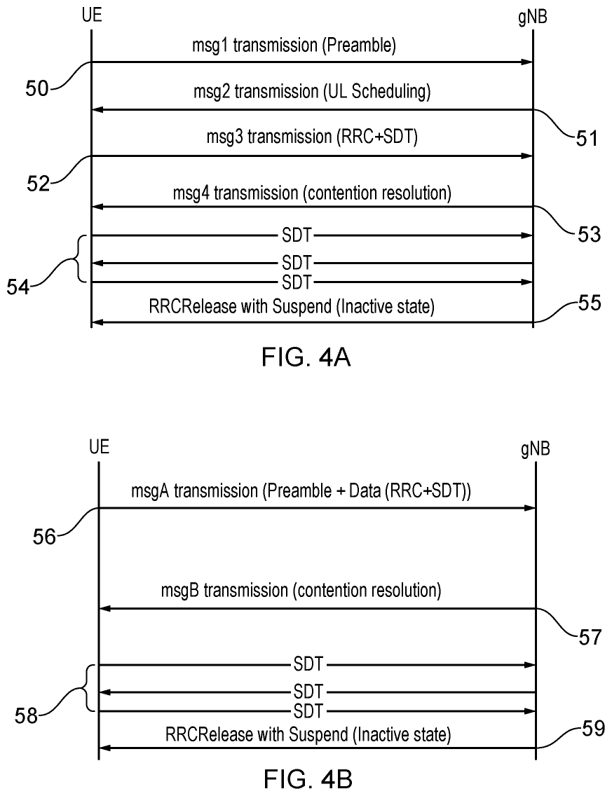

FIG. 4A shows an example of the 4-step RACH based scheme, and shows how MO SDTs can be initiated by such a scheme. When a UE has an UL SDT ready for transmission, it may start a 4-step RACH procedure as shown in FIG. 4A, which comprises the following steps:
A UE starts message 1 transmission 50 of a Physical Random Access (PRACH) preamble from a set of preambles allocated for SDT in the current cell. When a gNB receives the preambles, it identifies this as an SDT initiation, and responds with message 2;
The gNB transmits 51 message 2, which contains UL timing alignment command and UL PUSCH scheduling for message 3;
The UE transmits 52 message 3, which contains Radio Resource Control (RRC) signalling (i.e. RRCResumeRequest for initiating an SDT) and SDT data if there is any remaining space within the scheduled PUSCH;
Similarly to the general 4-step RACH procedure, the gNB then provides 53 the contention resolution after the UE that transmitted the preamble in the first step 50 is identified and confirmed. In this step 53, DL and UL feedback or acknowledgments are transmitted;
   For UL feedback received by a gNB from a UE in response to transmitting a DL PDSCH to that UE, a HARQ-ACK is transmitted on a cell-specific PUCCH resource configured within the system information (though it should be noted that, that from the third step 52, the UE is already UL-synchronised); and
   For DL feedback received by a UE in response to transmitting the UL message 3 in the third step 52, the reception of message 4 in the fourth step 53 at the UE is considered as a positive acknowledgment; and
After the fourth step 53, the UE is now already identified by the network and is also UL-synchronised. Hence, subsequent UL and DL SDT with dynamic scheduling can take place 54 as required while the UE remains in the INACTIVE state. Once SDT is completed, and neither the gNB or UE have any further small data to transmit, the gNB can choose to keep the UE in RRC_INACTIVE state by sending RRCRelease with suspend indication 55.

FIG. 4B shows an example of the 2-step RACH based scheme, and shows how MO SDTs can be initiated by such a scheme. When a UE has an UL SDT ready for transmission, it may start a 2-step RACH procedure as shown in FIG. 4B, which comprises the following steps;
A UE starts msgA transmission 56 of a PRACH preamble and associated PUSCH for SDT in the current cell. The PUSCH contains RRC signalling (i.e. RRCResumeRequest for initiating an SDT) and SDT data if there is any remaining space within the PUSCH;
Similarly to the general 2-step RACH procedure, when a gNB receives 56 msgA it identifies this as an SDT initiation and responds 57 with msgB which contains both an UL timing alignment command and the contention resolution where the UE which transmitted 56 msgA in the first step is identified and confirmed. In this step 57, DL and UL feedback or acknowledgments are transmitted;
   For UL feedback received by a gNB from a UE in response to a DL PDSCH being transmitted by the gNB to that UE, a HARQ-ACK is transmitted by the UE on a cell-specific PUCCH resource configured within the system information; and
   For DL feedback received by a UE from the gNB in response to msgA being transmitted 56 by that UE, the reception 57 of msgB at the UE is considered as a positive acknowledgment; and
After the second step 57, the UE is now already identified by the network and is also UL-synchronised. Hence, subsequent UL and DL SDT with dynamic scheduling can take place 54 as required while the UE remains in the INACTIVE state. Once SDT is completed, and neither the gNB or UE have any further small data to transmit, the gNB can choose to keep the UE in RRC_INACTIVE state by sending RR (Release with suspend indication 59.

When a UE remains in the same cell for a period of time, it is possible that the UE can use some pre-configured UL resources for transmitting data, provided that the UE is UL synchronised, while remaining in the INACTIVE state. Hence in Rel-17, it is agreed that a network can configure dedicated CG PUSCH resource(s) for SDT on a dedicated bandwidth part (BWP) or an initial BWP, just before a UE moves to the RRC_INACTIVE state. The usage of CG PUSCH resources may be validated based on some criteria; for example, the UL time alignment must not have expired and DL Reference Signal Received Power (RSRP) must not have changed significantly (e.g, by less than a delta value defined by the network). In addition, there is also a DL acknowledgment (i.e. an explicit or implicit HARQ-ACK feedback) for the transmitted CG-SDT. It should be noted that it is also allowed for a UE to be scheduled with a DL PDSCH after an initial transmission using a CG PUSCH (i.e. subsequent UL and DL SDT transmissions are possible).

In the current discussion for Rel-17 [7], upon arrival of UL data only for data radio bearer (DRB)/signalling radio bearer(s) (SRB(s)) for which SDT is enabled, the high-level procedure for selection between SDT and non SDT procedure is as follows:
If CG-SDT criteria is met; UE selects CG-SDT and initiates SDT procedure;
Else, if RA-SDT criteria is met; UE selects RA-SDT and initiates SDT procedure; and
Else: UE initiates non-SDT procedure.

The criteria for CG-SDT and RA-SDT, as identified in [7], are as follows:
CG-SDT criteria is considered met if all of the following conditions are satisfied;
   Available data volume is less than or equal to data volume threshold for SDT;
   RSRP is greater than or equal to a configured threshold; and
   CG-SDT resources are configured on the selected UL carrier and are valid; and
RA-SDT criteria is considered met if all of the following conditions are satisfied;
   Available data volume is less than or equal to data volume threshold for SDT;
   RSRP is greater than or equal to a configured threshold; and
   4 step RA-SDT resources are configured on the selected UL carrier and criteria to select
   4 step RA SDT is met; or 2 step RA-SDT resources are configured on the selected UL carrier and criteria to select 2 step RA SDT is met.

### Mobile Terminated Small Data Transmission (MT SDT)

While developments for supporting Small Data Transmissions (SDT) for uplink (aka mobile originated (MO) transmissions) in Inactive state are still ongoing for Rel-17, discussions relating to the need for mobile terminated (MT) transmissions in the downlink for SDT in Rel-18 have also begun, for example for positioning services or infrequent reception of small data at a UE in the Inactive state. Possible triggering mechanisms for MT-SDT (as discussed in greater detail in co-pending European patent application published under number EP3834524 [8], the contents of which are hereby incorporated by reference) may include:
Paging message to trigger SDT transmission in the DL;
Specific dynamic DCI to trigger SDT transmission in the DL; or
Semi-persistent scheduling (SPS) configuration to trigger SDT transmission in the DL.

In the case where a paging message is used to trigger a SDT transmission to a UE, it is obvious that when the UE receives such a paging trigger, the UE has to first synchronise with the network before receiving the DL SDT data. The reason for this is that the UE has to transmit HARQ-ACK feedback in the uplink (e.g, via a PUCCH) for the received DL SDT data, and needs to be synchronised with the network in order to transmit the HARQ-ACK feedback.

The UE may respond to the network request/indication in the triggering paging message in different ways or by using different procedures. One such way is that, if the UE is already configured with CG-SDT in the current cell, then the UE may be already synchronised with the network, and so can transmit an UL response (e.g., a CCCH message) on the CG resource straight away to indicate that it has successfully received the DL SDT data. Another way is that, if CG is not configured for the UE, the UE may trigger an SDT RACH procedure for synchronising with the network in the uplink. However, before executing the preferred UL response (e.g, the transmission of HARQ-ACK feedback), the UE must check certain conditions in response to receiving the paging-triggered SDT. Should one of more of these certain conditions not be met, then the UE may not be able to execute the preferred UL response, which means that the network may not know whether or not the SDT was successfully received and hence may determine that it needs to retransmit the SDT, or may unnecessarily command the UE to transition into the CONNECTED state-both of which increase power usage and reduce efficiency at the UE.

Accordingly, a problem required to be solved when a UE receives a paging trigger for an SDT transmission in the downlink (MT-SDT) is how the UE should respond in the UL to the SDT paging trigger dependent on such conditions, such that the network is able to transmit the SDT in such a way that the UE is able to respond in the UL. Embodiments of the present technique provide solutions to this problem relating both to the conditions that the UE (operating in INACTIVE state) has to check before responding to the network and to the procedures that the UE (operating in INACTIVE state) is to follow when some of these conditions are not met.

### DL SDT Procedures and Conditions During Inactive State

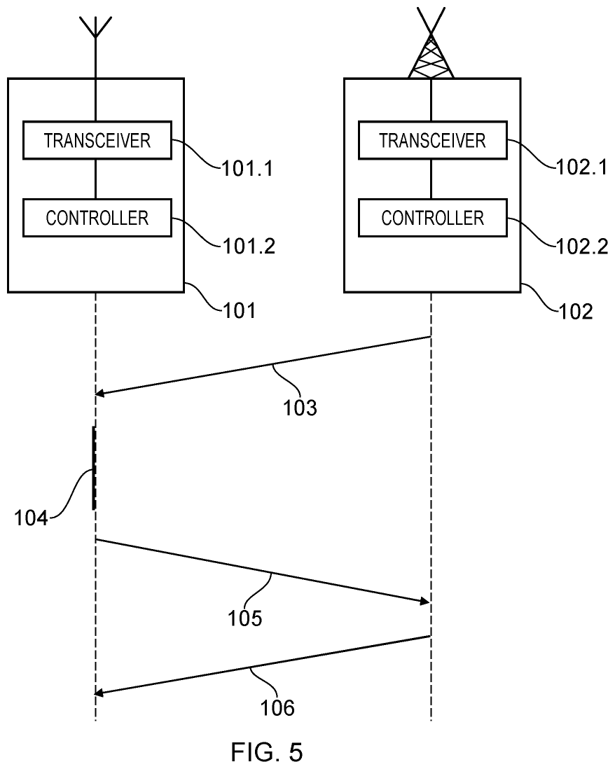

FIG. 5 shows a part schematic, part message flow diagram representation of a first wireless communications system comprising a communications device 101 and an infrastructure equipment 102 in accordance with at least some embodiments of the present technique. The communications device 101 is configured to transmit signals to and/or receive signals from the wireless communications network, for example, to and from the infrastructure equipment 102. Specifically, the communications device 101 may be configured to transmit data to and/or receive data from the wireless communications network (e.g, to/from the infrastructure equipment 102) via a wireless radio interface provided by the wireless communications network (e.g, a Uu interface between the communications device 101 and the Radio Access Network (RAN), which includes the infrastructure equipment 102). The communications device 101 and the infrastructure equipment 102 each comprise a transceiver (or transceiver circuitry) 101.1, 102.1, and a controller (or controller circuitry) 101.2, 102.2. Each of the controllers 101.2, 102.2 may be, for example, a microprocessor, a CPU, or a dedicated chipset, etc.

As shown in the example of FIG. 5, the transceiver circuitry 101.1 and the controller circuitry 101.2 of the communications device 101 are configured in combination, while the communications device is operating in an inactive state, to receive 103, from the wireless communications network (e.g, from the infrastructure equipment 102), a paging message, the paging message indicating that the wireless communications network (e.g, the infrastructure equipment 102) is to transmit, to the communications device 101, a downlink small data transmission. SDT, to determine 104, in response to receiving 103 the paging message, whether or not one or more predetermined conditions for reception of the downlink SDT are met, to transmit 105, to the wireless communications network (e.g, to the infrastructure equipment 102), an indication of whether or not the one or more predetermined conditions are met, and to receive 106 the downlink SDT from the wireless communications network (e.g, from the infrastructure equipment 102) in a manner dependent on whether or not the one or more predetermined conditions are met.

Essentially, embodiments of the present technique propose that a UE checks certain conditions when responding to paging-triggered MT-SDT in INACTIVE state, where such conditions check firstly whether the UE is able to receive and respond to the MT-SDT, and secondly how this procedure should be carried out. These conditions can be configured explicitly or implicitly. It is assumed here that:
The UE is (or at least, should be) configured with at least one radio bearer for DL SDT (i.e. the radio bearer that will transport the downlink SDT) in the RRCRelease with suspend indication. This radio bearer may have an identifier or ID associated with it;
The UE is configured with a DL RSRP threshold via system information in order to exclude cell-edge UEs in large cells from receiving DL SDT data (because while such UEs may be able to receive such DL SDT data, the problem here may be in the transmission of feedback by such UEs in the uplink); and
The UE is configured with an UL SDT Data Volume Threshold (DVT) via system information in order to exclude the transmission of large data (if any) in the uplink when responding to paging-triggered MT-SDT.

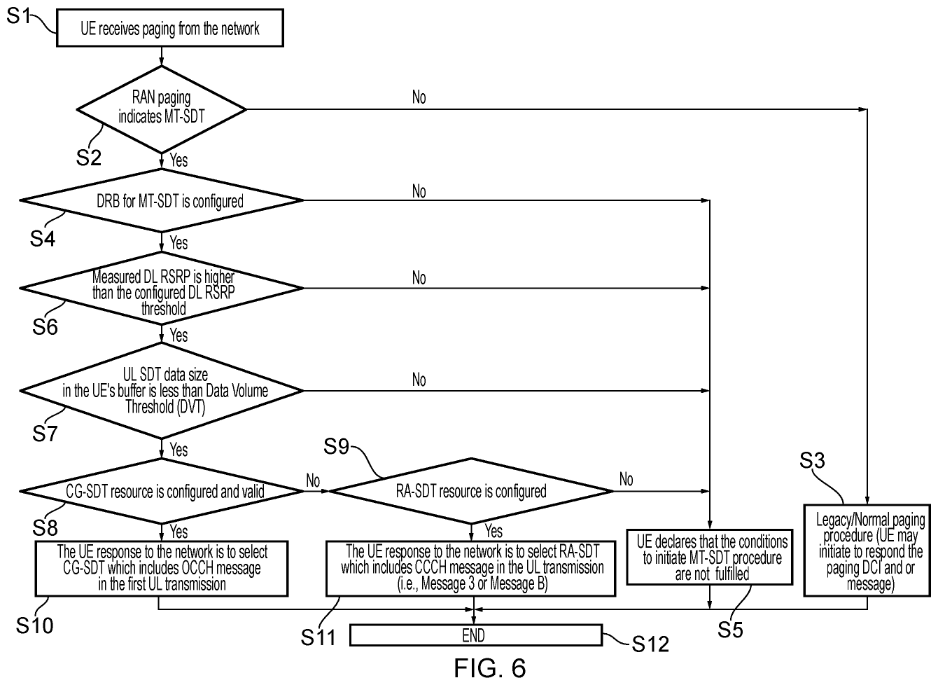

FIG. 6 shows a flow diagram illustrating a first example process of communications in a communications system in accordance with embodiments of the present technique. The process shown by FIG. 6 is an example of an overall procedure performed by a UE with respect to determining whether or not certain conditions are satisfied upon receiving a paging message triggering downlink MT-SDT, and the steps that should be taken by the UE dependent on which conditions are or are not satisfied. At a certain point before the method shown by the example of FIG. 6 begins, the network has moved the UE to the RRC_INACTIVE state by sending the RRCRelease with suspendConfig indication.

The method begins in step S1, where the UE receives radio access network (RAN) paging from the network. In step S2, the UE reads the paging message to determine whether or not it triggers MT-SDT/DL SDT, or whether instead it relates to a legacy or normal paging procedure. In the latter case, the process moves to step S3, where the UE may perform an action or transmit a response to the network in response to the legacy/non-MT-SDT paging message and/or paging DCI appropriately. However, if the paging message does trigger MT-SDT, then the process moves to step S4. Here, in steps S4, S6, S7, S8 and S9 of the example process of FIG. 6, the UE may check the several conditions based on the contents of the paging message.

The contents of the paging message may include one or more of:
A new cause value or similar indication is expected to be included in the paging message so that the UE is able to be aware that the paging message is for DL-SDT. Currently, paging messages include the UE ID and access type (which is applicable for non-3GPP access only). In other words, the paging message may comprise a flag that indicates that the wireless communications network is to transmit the downlink SDT to the communications device;
The paging message may carry the radio bearer ID of the radio bearer used to carry DL-SDT data to the UE. In other words, the paging message may include an identifier of a data radio bearer that is to be used to transport the downlink SDT from the wireless communications network to the communications device. Those skilled in the art would note that the radio bearer ID is unique per UE; and
The paging message may, instead of (or in addition to) the radio bearer ID, indicate the logical channel ID and/or the RLC channel ID. In other words, the paging message may include an identifier of a logical channel that is to be used for the transport of data associated with the downlink SDT, and/or the paging message may include an identifier of an RLC channel that is to be used for the transport of data associated with the downlink SDT. Alternatively, a universal radio bearer ID or logical channel ID may be reserved for DL-SDT for all UEs.

The UE may be configured in accordance with the example process of FIG. 6 to check one or more of the following conditions:
At least one radio bearer/logical channel/RLC channel for DL SDT is configured (e.g, as shown in step S4 of the example of FIG. 6). In other words, the one or more predetermined conditions may comprise at least one data radio bearer having been configured for the communications device to receive the downlink SDT from the wireless communications network while operating in the inactive state, and/or the one or more predetermined conditions may comprise a logical channel having been configured for the communications device to receive data associated with the downlink SDT from the wireless communications network while operating in the inactive state, and/or the one or more predetermined conditions comprise a radio link control. RLC, channel having been configured for the communications device to receive data associated with the downlink SDT from the wireless communications network while operating in the inactive state;
The measured downlink RSRP/RSRP of the downlink pathloss reference is higher than the configured DL RSRP threshold (e.g, as shown in step S6 of the example of FIG. 6). In other words, the one or more predetermined conditions may comprise a measured quality of reference signals received by the communications device from the wireless communications network being higher than a preconfigured threshold quality required for the communications device to receive signals from the wireless communications network;
   Here, the configured DL RSRP threshold may be common for both DL and UL SDT (i.e. the same threshold value). In other words, the preconfigured threshold quality required for the communications device to receive signals from the wireless communications network may be the same as a preconfigured threshold quality required for the communications device to transmit signals to the wireless communications network;
The UE also checks that the UL SDT data size in its buffer is less than Data Volume Threshold (DVT) (e.g, as shown in step S7 of the example of FIG. 6). In other words, the one or more predetermined conditions may comprise an amount of data currently stored in a buffer of the communications device being lower than a preconfigured threshold amount. If there is no UL SDT, the data size will be zero, which makes this condition always applicable even when there is no UL data available. However, in most cases, the availability of uplink data may be coincidental; for example, by the time UE receives the triggering of DL SDT, there may also be UL SDT data that has just arrived at the UE's buffer for transmission; and
The UE checks whether there is an uplink SDT resource configured for it (e.g., as shown in steps S8 and S9 of the example of FIG. 6).

If, in any of steps S4, S6, or S7, the UE determines that the condition is not satisfied, then the process advances to step S5, in which it declares that the conditions required to initiate the MT-SDT procedure are not fulfilled, and indicates this to the network. In other words, the communications device may be configured, if at least one of the one or more predetermined conditions are not met, to transmit, to the wireless communications network, a message indicating that the one or more conditions are not met and therefore that the communications device is not able to receive the downlink SDT from the wireless communications network while operating in the inactive state.

In such a case, the UE may then initiate the procedure to move from RRC_INACTIVE to RRC_CONNECTED, so that it is able to receive (and acknowledge) the downlink SDT data and indeed any other data of any size in CONNECTED mode. In other words, the communications device may be configured to transition from the inactive state to a connected state (for example by initiating legacy RACH procedure), to receive, while in the connected state, downlink data (which may be the downlink SDT data or other SDT/non-SDT data) from the wireless communications network, and to transmit, to the wireless communications network while in the connected state, a feedback signal indicating whether or not the downlink data (which may be the downlink SDT data or other SDT/non-SDT data) was successfully received by the communications device. Following the receipt and acknowledgement of the downlink data, the UE may then move back into RRC_INACTIVE, or move to the RRC_IDLE state. In other words, the communications device may be configured to transition, after transmitting the feedback signal to the wireless communications network, from the connected state back to the inactive state, or to transition, after transmitting the feedback signal to the wireless communications network, from the connected state to an idle state.

The UE's behaviour may also depend based on whether it is determined in step S8 (and indeed step S9) whether or not there is an uplink SDT resource configured for the UE. In other words, the one or more predetermined conditions may comprise a set of grant-free resources of the wireless radio interface having been configured for the communications device in which the communications device is able to transmit uplink SDTs to the wireless communications network and the grant-free resources being valid at the time at which the downlink SDT is to be received from the wireless communications network. Here, the grant-free resources being “valid” may comprise an time alignment timer associated with the grant-free resources not having expired, the time alignment timer indicating a time period during which the communications device is synchronised with the wireless communications network in the uplink and/or in the downlink That is:
If the UE determines in step S8 that a CG-SDT resource is configured and valid (i.e. the UL time-alignment timer has not expired), the UE response to the network, in step S10, is to select CG-SDT for transmission of the feedback for the MT-SDT which may include a CCCH message in the first UL transmission, and therefore (based on this CCCH message indicating a positive response) the UE is able to receive the MT-SDT whilst still in RRC_INACTIVE. In other words, the communications device may be configured, if the grant-free resources are configured and valid, to transmit a feedback signal to the wireless communications network within the grant-free resources, the feedback signal indicating that the communications device is able to receive the downlink SDT from the wireless communications network while operating in the inactive state. Here, the feedback signal is transmitted within a common control channel. CCCH message, the transmission of the CCCH message indicating that the communications device is able to receive the downlink SDT from the wireless communications network while operating in the inactive state; or
If the UE determines in step S8 that a CG-SDT resource is not configured or not valid, the UE then determines in step S9 whether or not an RA-SDT resource is configured for the UE. In other words, the one or more predetermined conditions may comprise a set of random access resources of the wireless radio interface having been configured for the communications device in which the communications device is able to initiate a random access procedure to transmit uplink SDTs to the wireless communications network;
   If the UE determines in step S9 that an RA-SDT resource is configured, then the UE's response to the network (in step S11) is to select RA-SDT for transmission of the feedback for the MT-SDT which may include a CCCH message in the UL transmission (i.e. Message 3 or Message A), and therefore to receive the MT-SDT whilst still in RRC_INACTIVE. In other words, the communications device may be configured, if the grant-free resources are not configured and/or are not valid and if the random access resources are configured, to initiate a random access procedure with the wireless communications network, wherein an uplink message of the random access procedure transmitted by the communications device to the wireless communications network comprises a feedback signal indicating that the communications device is able to receive the downlink SDT from the wireless communications network while operating in the inactive state. Here, the feedback signal is transmitted within a common control channel. CCCH message, the transmission of the CCCH message indicating that the communications device is able to receive the downlink SDT from the wireless communications network while operating in the inactive state; or
   If the UE determines in step S9 that an RA-SDT resource is not configured, then the UE's response to the network (in step S5) is to declare that the conditions required to initiate the MT-SDT procedure are not fulfilled, and indicates this to the network. In other words, the communications device may be configured, if the grant-free resources are not configured and/or are not valid and if the random access resources are not configured, to transmit, to the wireless communications network, a message indicating that the one or more conditions are not met and therefore that the communications device is not able to receive the downlink SDT from the wireless communications network while operating in the inactive state. In such a case, the UE may then again initiate the procedure to move from RRC_INACTIVE to RRC_CONNECTED, so that it is able to receive (and acknowledge) the downlink SDT. In other words, the communications device may be configured to initiate a random access procedure with the wireless communications network in response to the received paging message, wherein the message indicating that the one or more conditions are not met and therefore that the communications device is not able to receive the downlink SDT from the wireless communications network while operating in the inactive state is (for example) an uplink message of the random access procedure transmitted by the communications device to the wireless communications network which comprises an indication of a cause for the initiation of the random access procedure (e.g, where this cause is mobile terminated data arrival, which will allow the network to understand the reason for the initiation of the RACH procedure or other message indicating the one or more conditions are not met), and to receive, from the wireless communications network in a downlink message of the random access procedure, a configuration of the communications device for the communications device to receive downlink data from the wireless communications network. Here, the configuration of the communications device for the communications device to receive downlink data from the wireless communications network may comprise transitioning, by the communications device, from the inactive state to a connected state, wherein the communications device is able, while in the connected state, to receive the downlink SDT from the wireless communications network-though the network may alternatively instruct the UE to stay in the inactive state, and will in the case of the RACH procedure inform the UE of this decision (inactive or connected) in the RRC Resume message. Following the receipt and acknowledgement of the downlink SDT, the UE may then again move back into RRC_INACTIVE, or move to the RRC_IDLE state. In other words, the communications device may be configured to transition, after transmitting the feedback signal to the wireless communications network, from the connected state back to the inactive state, or to transition, after transmitting the feedback signal to the wireless communications network, from the connected state to an idle state; or
   In some other arrangements of embodiments of the present technique, if CG-SDT resources and RA-SDT resources are not configured for a UE, but the UE is in the RRC_INACTIVE state and has received a DL-SDT paging message, the UE may in this case perform a RACH procedure using normal RACH resources (i.e. not using RACH resources from a separate partitioning). The UE may then include a new resume cause in the RRC Resume Request message, where this new cause would inform the gNB that the UE has responded to DL-SDT paging message. The gNB may then configure the UE to stay in the INACTIVE state in the RRC Resume message, and subsequently to receive DL data. In other words, the communications device may be configured, if the grant-free resources are not configured and/or are not valid and if the random access resources are not configured, to initiate a random access procedure with the wireless communications network in response to the received paging message, wherein an uplink message of the random access procedure transmitted by the communications device to the wireless communications network comprises an indication of a cause for the initiation of the random access procedure, and to receive, from the wireless communications network in a downlink message of the random access procedure, a configuration of the communications device for the communications device to receive downlink data from the wireless communications network. The benefit of this approach is that DL-SDT and UL-SDT can be independently configured for different UEs; i.e. the DL-SDT procedure works without CG-SDT and special RACH resource partitioning being configured. The UE may use an existing resume cause while responding to the paging message, and the network should be able to extract the UE context based on the RRC Resume Request message received from the UE and then decide if UE stays in the inactive mode or moves to the connected mode. This decision is informed to the UE in the RRC Resume message.

Following performance of any one of steps S3, S5, S10, or S11, the example process of FIG. 6 ends in step S12.

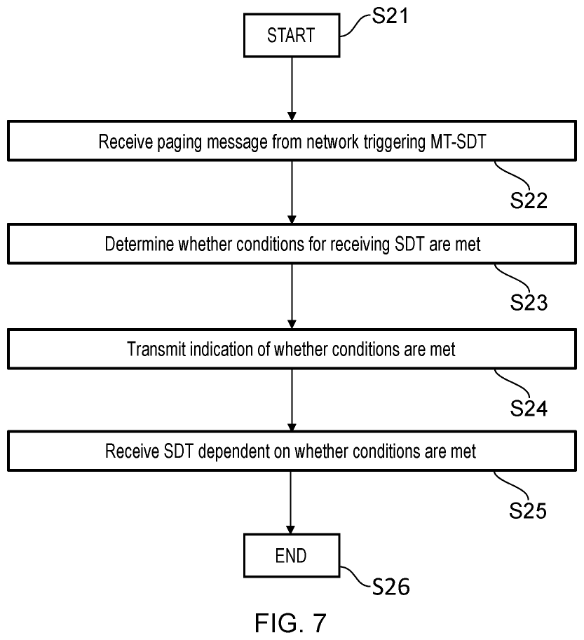

FIG. 7 shows a flow diagram illustrating a second example process of communications in a communications system in accordance with embodiments of the present technique. The process shown by FIG. 7 is a method of operating a communications device configured to transmit signals to and/or to receive signals from a wireless communications network (e.g, to or from an infrastructure equipment of the wireless communications network).

The method, which is performed while the communications device is operating in an inactive state, begins in step S21. The method comprises, in step S22, receiving, from the wireless communications network, a paging message, the paging message indicating that the wireless communications network is to transmit, to the communications device, a downlink small data transmission. SDT. In step S23, the process comprises determining, in response to receiving the paging message, whether or not one or more predetermined conditions for reception of the downlink SDT are met. The method then comprises, in step S24, transmitting, to the wireless communications network, an indication of whether or not the one or more predetermined conditions are met. Following this, in step S25, the process comprises receiving the downlink SDT from the wireless communications network in a manner dependent on whether or not the one or more predetermined conditions are met. The process ends in step S26.

Those skilled in the art would appreciate that the method shown by FIG. 7 may be adapted in accordance with embodiments of the present technique. For example, other intermediate steps may be included in this method, or the steps may be performed in any logical order. Furthermore, though embodiments of the present technique have been described largely by way of the example communications system shown in FIG. 5, and described by way of the example flow diagrams of FIGS. 6 and 7, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may, without departing from the scope of the claims, form part of communications systems other than those defined by the present disclosure.

The following numbered paragraphs provide further example aspects and features of the present technique:
Paragraph 1. A method of operating a communications device configured to transmit signals to and/or to receive signals from a wireless communications network via a wireless radio interface provided by the wireless communications network, the method comprising, while the communications device is operating in an inactive state.
   receiving, from the wireless communications network, a paging message, the paging message indicating that the wireless communications network is to transmit, to the communications device, a downlink small data transmission, SDT.
   determining, in response to receiving the paging message, whether or not one or more predetermined conditions for reception of the downlink SDT are met.
   transmitting, to the wireless communications network, an indication of whether or not the one or more predetermined conditions are met, and receiving the downlink SDT from the wireless communications network in a manner dependent on whether or not the one or more predetermined conditions are met.
Paragraph 2. A method according to Paragraph 1, wherein the one or more predetermined conditions comprise a set of grant-free resources of the wireless radio interface having been configured for the communications device in which the communications device is able to transmit uplink SDTs to the wireless communications network and the grant-free resources being valid at the time at which the downlink SDT is to be received from the wireless communications network.
Paragraph 3. A method according to Paragraph 2, wherein the grant-free resources being valid comprises an time alignment timer associated with the grant-free resources not having expired, the time alignment timer indicating a time period during which the communications device is synchronised with the wireless communications network in the uplink and/or in the downlink.
Paragraph 4. A method according to Paragraph 2 or Paragraph 3, comprising, if the grant-free resources are configured and valid,
   transmitting a feedback signal to the wireless communications network within the grant-free resources, the feedback signal indicating that the communications device is able to receive the downlink SDT from the wireless communications network while operating in the inactive state.
Paragraph 5. A method according to Paragraph 4, wherein the feedback signal is transmitted within a common control channel. CCCH message, the transmission of the CCCH message indicating that the communications device is able to receive the downlink SDT from the wireless communications network while operating in the inactive state.
Paragraph 6. A method according to any of Paragraphs 2 to 5, wherein the one or more predetermined conditions comprise a set of random access resources of the wireless radio interface having been configured for the communications device in which the communications device is able to initiate a random access procedure to transmit uplink SDTs to the wireless communications network.
Paragraph 7. A method according to Paragraph 6, comprising, if the grant-free resources are not configured and/or are not valid and if the random access resources are configured,
   initiating a random access procedure with the wireless communications network, wherein an uplink message of the random access procedure transmitted by the communications device to the wireless communications network comprises a feedback signal indicating that the communications device is able to receive the downlink SDT from the wireless communications network while operating in the inactive state.
Paragraph 8. A method according to Paragraph 7, wherein the feedback signal is transmitted within a common control channel. CCCH message, the transmission of the CCCH message indicating that the communications device is able to receive the downlink SDT from the wireless communications network while operating in the inactive state.
Paragraph 9. A method according to Paragraph 7 or Paragraph 8, comprising, if the grant-free resources are not configured and/or are not valid and if the random access resources are not configured,
   transmitting, to the wireless communications network, a message indicating that the one or more conditions are not met and therefore that the communications device is not able to receive the downlink SDT from the wireless communications network while operating in the inactive state.
Paragraph 10. A method according to any of Paragraphs 7 to 9, comprising, if the grant-free resources are not configured and/or are not valid and if the random access resources are not configured.
   initiating a random access procedure with the wireless communications network in response to the received paging message, wherein an uplink message of the random access procedure transmitted by the communications device to the wireless communications network comprises an indication of a cause for the initiation of the random access procedure, and
   receiving, from the wireless communications network in a downlink message of the random access procedure, a configuration of the communications device for the communications device to receive downlink data from the wireless communications network.
Paragraph 11. A method according to any of Paragraphs 1 to 10, wherein the one or more predetermined conditions comprise at least one data radio bearer having been configured for the communications device to receive the downlink SDT from the wireless communications network while operating in the inactive state.
Paragraph 12. A method according to any of Paragraphs 1 to 11, wherein the one or more predetermined conditions comprise a logical channel having been configured for the communications device to receive data associated with the downlink SDT from the wireless communications network while operating in the inactive state.
Paragraph 13. A method according to any of Paragraphs 1 to 12, wherein the one or more predetermined conditions comprise a radio link control, RLC, channel having been configured for the communications device to receive data associated with the downlink SDT from the wireless communications network while operating in the inactive state.
Paragraph 14. A method according to any of Paragraphs 1 to 13, wherein the one or more predetermined conditions comprise a measured quality of reference signals received by the communications device from the wireless communications network being higher than a preconfigured threshold quality required for the communications device to receive signals from the wireless communications network.
Paragraph 15. A method according to Paragraph 14, wherein the preconfigured threshold quality required for the communications device to receive signals from the wireless communications network is the same as a preconfigured threshold quality required for the communications device to transmit signals to the wireless communications network.
Paragraph 16. A method according to any of Paragraphs 1 to 15, wherein the one or more predetermined conditions comprise an amount of data currently stored in a buffer of the communications device being lower than a preconfigured threshold amount.
Paragraph 17. A method according to any of Paragraphs 1 to 16, comprising, if at least one of the one or more predetermined conditions are not met,
   transmitting, to the wireless communications network, a message indicating that the one or more conditions are not met and therefore that the communications device is not able to receive the downlink SDT from the wireless communications network while operating in the inactive state.
Paragraph 18. A method according to Paragraph 17, comprising
   initiating a random access procedure with the wireless communications network in response to the received paging message, wherein the message indicating that the one or more conditions are not met and therefore that the communications device is not able to receive the downlink SDT from the wireless communications network while operating in the inactive state is an uplink message of the random access procedure transmitted by the communications device to the wireless communications network which comprises an indication of a cause for the initiation of the random access procedure, and
   receiving, from the wireless communications network in a downlink message of the random access procedure, a configuration of the communications device for the communications device to receive downlink data from the wireless communications network.
Paragraph 19. A method according to Paragraph 18, wherein the configuration of the communications device for the communications device to receive downlink data from the wireless communications network comprises transitioning, by the communications device, from the inactive state to a connected state, wherein the communications device is able, while in the connected state, to receive the downlink SDT from the wireless communications network.
Paragraph 20. A method according to Paragraph 19, comprising
   transitioning, after receiving the downlink SDT from the wireless communications network, from the connected state back to the inactive state.
Paragraph 21. A method according to Paragraph 19 or Paragraph 20, comprising
   transitioning, after receiving the downlink SDT from the wireless communications network, from the connected state to an idle state.
Paragraph 22. A method according to any of Paragraphs 1 to 21, wherein the paging message comprises a flag that indicates that the wireless communications network is to transmit the downlink SDT to the communications device.
Paragraph 23. A method according to any of Paragraphs 1 to 22, wherein the paging message includes an identifier of a data radio bearer that is to be used to transport the downlink SDT from the wireless communications network to the communications device.
Paragraph 24. A method according to any of Paragraphs 1 to 23, wherein the paging message includes an identifier of a logical channel that is to be used for the transport of data associated with the downlink SDT.
Paragraph 25. A method according to any of Paragraphs 1 to 24, wherein the paging message includes an identifier of an RLC channel that is to be used for the transport of data associated with the downlink SDT.
Paragraph 26. A communications device configured to transmit signals to and/or to receive signals from a wireless communications network, the communications device comprising
   transceiver circuitry configured to transmit signals and receive signals via a wireless radio interface provided by the wireless communications network, and
   controller circuitry configured in combination with the transceiver circuitry, while the communications device is operating in an inactive state.
   to receive, from the wireless communications network, a paging message, the paging message indicating that the wireless communications network is to transmit, to the communications device, a downlink small data transmission, SDT,
   to determine, in response to receiving the paging message, whether or not one or more predetermined conditions for reception of the downlink SDT are met.
   to transmit, to the wireless communications network, an indication of whether or not the one or more predetermined conditions are met, and
   to receive the downlink SDT from the wireless communications network in a manner dependent on whether or not the one or more predetermined conditions are met.
Paragraph 27. Circuitry for a communications device configured to transmit signals to and/or to receive signals from a wireless communications network, the communications device comprising
   transceiver circuitry configured to transmit signals and receive signals via a wireless radio interface provided by the wireless communications network, and
   controller circuitry configured in combination with the transceiver circuitry, while the communications device is operating in an inactive state.
   to receive, from the wireless communications network, a paging message, the paging message indicating that the wireless communications network is to transmit, to the communications device, a downlink small data transmission, SDT,
   to determine, in response to receiving the paging message, whether or not one or more predetermined conditions for reception of the downlink SDT are met.
   to transmit, to the wireless communications network, an indication of whether or not the one or more predetermined conditions are met, and
   to receive the downlink SDT from the wireless communications network in a manner dependent on whether or not the one or more predetermined conditions are met.
Paragraph 28. A method of operating an infrastructure equipment forming part of a wireless communications network configured to transmit signals to and/or to receive signals from a communications device via a wireless radio interface provided by the infrastructure equipment, the method comprising.
   transmitting, to the communications device, a paging message, the paging message indicating that the infrastructure equipment is to transmit, to the communications device, a downlink small data transmission, SDT,

receiving from the communications device, in response to transmitting the paging message, an indication of whether or not one or more predetermined conditions for reception of the downlink SDT by the communications device are met, and transmitting the downlink SDT to the communications device in a manner dependent on whether or not the one or more predetermined conditions are met.
Paragraph 29. A method according to Paragraph 28, wherein the one or more predetermined conditions comprise a set of grant-free resources of the wireless radio interface having been configured for the communications device in which the communications device is able to transmit uplink SDTs to the infrastructure equipment and the grant-free resources being valid at the time at which the downlink SDT is to be transmitted by the infrastructure equipment.
Paragraph 30. A method according to Paragraph 29, wherein the grant-free resources being valid comprises an time alignment timer associated with the grant-free resources not having expired, the time alignment timer indicating a time period during which the communications device is synchronised with the infrastructure equipment in the uplink and/or in the downlink.
Paragraph 31. A method according to Paragraph 29 or Paragraph 30, comprising, if the grant-free resources are configured and valid,
   receiving a feedback signal from the communications device within the grant-free resources, the feedback signal indicating that the communications device is able to receive the downlink SDT from the infrastructure equipment while operating in the inactive state.
Paragraph 32. A method according to Paragraph 31, wherein the feedback signal is received within a common control channel. CCCH message, the reception of the CCCH message indicating that the communications device is able to receive the downlink SDT from the wireless communications network while operating in the inactive state.
Paragraph 33. A method according to any of Paragraphs 29 to 32, wherein the one or more predetermined conditions comprise a set of random access resources of the wireless radio interface having been configured for the communications device in which the communications device is able to initiate a random access procedure to transmit uplink SDTs to the infrastructure equipment.
Paragraph 34. A method according to Paragraph 33, comprising, if the grant-free resources are not configured and/or are not valid and if the random access resources are configured.
   receiving from the communications device, within an uplink message of a random access procedure initiated by the communications device with the infrastructure equipment, a feedback signal indicating that the communications device is able to receive the downlink SDT from the infrastructure equipment while operating in the inactive state.
Paragraph 35. A method according to Paragraph 34, wherein the feedback signal is received within a common control channel. CCCH message, the reception of the CCCH message indicating that the communications device is able to receive the downlink SDT from the wireless communications network while operating in the inactive state.
Paragraph 36. A method according to any of Paragraphs 33 to 35, comprising, if the grant-free resources are not configured and/or are not valid and if the random access resources are not configured.
   receiving, from the communications device, a message indicating that the one or more conditions are not met and therefore that the communications device is not able to receive the downlink SDT from the infrastructure equipment while operating in the inactive state.
Paragraph 37. A method according to any of Paragraphs 33 to 36, comprising, if the grant-free resources are not configured and/or are not valid and if the random access resources are not configured, receiving from the communications device, within an uplink message of a random access procedure initiated by the communications device with the infrastructure equipment, an indication of a cause for the initiation of the random access procedure, and transmitting, to the communications device in a downlink message of the random access procedure, a configuration of the communications device for the communications device to receive downlink data from the infrastructure equipment.
Paragraph 38. A method according to any of Paragraphs 28 to 37, wherein the one or more predetermined conditions comprise at least one data radio bearer having been configured for the communications device to receive the downlink SDT from the infrastructure equipment while operating in the inactive state.
Paragraph 39. A method according to any of Paragraphs 28 to 38, wherein the one or more predetermined conditions comprise a logical channel having been configured for the communications device to receive data associated with the downlink SDT from the infrastructure equipment while operating in the inactive state.
Paragraph 40. A method according to any of Paragraphs 28 to 39, wherein the one or more predetermined conditions comprise a radio link control. RLC, channel having been configured for the communications device to receive data associated with the downlink SDT from the infrastructure equipment while operating in the inactive state.
Paragraph 41. A method according to any of Paragraphs 28 to 40, wherein the one or more predetermined conditions comprise a measured quality of reference signals received by the communications device from the infrastructure equipment being higher than a preconfigured threshold quality required for the communications device to receive signals from the infrastructure equipment.
Paragraph 42. A method according to Paragraph 41, wherein the preconfigured threshold quality required for the communications device to receive signals from the infrastructure equipment is the same as a preconfigured threshold quality required for the communications device to transmit signals to the infrastructure equipment.
Paragraph 43. A method according to any of Paragraphs 28 to 42, wherein the one or more predetermined conditions comprise an amount of data currently stored in a buffer of the communications device being lower than a preconfigured threshold amount.
Paragraph 44. A method according to any of Paragraphs 28 to 43, comprising, if at least one of the one or more predetermined conditions are not met.
   receiving, from the communications device, a message indicating that the one or more conditions are not met and therefore that the communications device is not able to receive the downlink SDT from the infrastructure equipment while operating in the inactive state.
Paragraph 45. A method according to Paragraph 44, comprising
   receiving from the communications device, as an uplink message of a random access procedure initiated by the communications device with the infrastructure equipment, the message indicating that the one or more conditions are not met and therefore that the communications device is not able to receive the downlink SDT from the infrastructure equipment while operating in the inactive state, wherein the uplink message of the random access procedure comprises an indication of a cause for the initiation of the random access procedure, and
   transmitting, to the communications device in a downlink message of the random access procedure, a configuration of the communications device for the communications device to receive downlink data from the infrastructure equipment.
Paragraph 46. A method according to Paragraph 45, wherein the configuration of the communications device for the communications device to receive downlink data from the infrastructure equipment comprises transitioning, by the communications device, from the inactive state to a connected state, wherein the communications device is able, while in the connected state, to receive the downlink SDT from the infrastructure equipment.
Paragraph 47. A method according to Paragraph 46, comprising
   determining that the communications device is to transition, after receiving the downlink SDT from the infrastructure equipment, from the connected state back to the inactive state.
Paragraph 48. A method according to Paragraph 46 or Paragraph 47, comprising
   determining that the communications device is to transition, after receiving the downlink SDT from the infrastructure equipment, from the connected state to an idle state.
Paragraph 49. A method according to any of Paragraphs 28 to 48, wherein the paging message comprises a flag that indicates that the infrastructure equipment is to transmit the downlink SDT to the communications device.
Paragraph 50. A method according to any of Paragraphs 28 to 49, wherein the paging message includes an identifier of a data radio bearer that is to be used to transport the downlink SDT from the infrastructure equipment to the communications device.
Paragraph 51. A method according to any of Paragraphs 28 to 50, wherein the paging message includes an identifier of a logical channel that is to be used for the transport of data associated with the downlink SDT.
Paragraph 52. A method according to any of Paragraphs 28 to 51, wherein the paging message includes an identifier of an RLC channel that is to be used for the transport of data associated with the downlink SDT.
Paragraph 53. An infrastructure equipment forming part of a wireless communications network configured to transmit signals to and/or to receive signals from a communications device, the infrastructure equipment comprising
   transceiver circuitry configured to transmit signals and receive signals via a wireless radio interface provided by the infrastructure equipment, and
   controller circuitry configured in combination with the transceiver circuitry, while the communications device is operating in an inactive state,
   to transmit, to the communications device, a paging message, the paging message indicating that the infrastructure equipment is to transmit, to the communications device, a downlink small data transmission, SDT,
   to receive from the communications device, in response to transmitting the paging message, an indication of whether or not one or more predetermined conditions for reception of the downlink SDT by the communications device are met, and
   to transmit the downlink SDT to the communications device in a manner dependent on whether or not the one or more predetermined conditions are met.
Paragraph 54. Circuitry for an infrastructure equipment forming part of a wireless communications network configured to transmit signals to and/or to receive signals from a communications device, the infrastructure equipment comprising
   transceiver circuitry configured to transmit signals and receive signals via a wireless radio interface provided by the infrastructure equipment, and
   controller circuitry configured in combination with the transceiver circuitry, while the communications device is operating in an inactive state,
   to transmit, to the communications device, a paging message, the paging message indicating that the infrastructure equipment is to transmit, to the communications device, a downlink small data transmission, SDT,
   to receive from the communications device, in response to transmitting the paging message, an indication of whether or not one or more predetermined conditions for reception of the downlink SDT by the communications device are met, and
   to transmit the downlink SDT to the communications device in a manner dependent on whether or not the one or more predetermined conditions are met.
Paragraph 55. A telecommunications system comprising a communications device according to Paragraph 26 and an infrastructure equipment according to Paragraph 53.
Paragraph 56. A computer program comprising instructions which, when loaded onto a computer, cause the computer to perform a method according to any of Paragraphs 1 to 25 or Paragraphs 28 to 52.
Paragraph 57. A non-transitory computer-readable storage medium storing a computer program according to Paragraph 56.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H, and Toskala A, “LTE for UMTS OFDMA and SC-FDMA based radio access”, John Wiley and Sons, 2009.
[2] RP-192330, “New work item: 2-step RACH for NR,” ZTE Corporation, 3GPP TSG RAN Meeting #85.
[3] RP-192324, “Revised WID: Support of NR Industrial Internet of Things (IoT),” Nokia, Nokia Shanghai Bell, 3GPP TSG RAN Meeting #85.
[4] RP-191575, “NR-based Access to Unlicensed Spectrum,” Qualcomm, Inc., 3GPP TSG RAN Meeting #84.
[5] RP-193252, “New Work Item on NR small data transmission in INACTIVE state,” ZTE Corporation, 3GPP TSG RAN Meeting #86.
[6] RP-213583, “New WI: Mobile Terminated-Small Data Transmission (MT-SDT) for NR”, 3GPP.
[7] R2-2102707, “Report from email discussion [POST113-e][501] [SDT] Selection criteria and overall Procedure,” Samsung, 3GPP RAN WG2 Meeting #113bis-e.
[8] European patent application published under number EP3834524.

1. A method of operating a communications device configured to transmit signals to and/or to receive signals from a wireless communications network via a wireless radio interface provided by the wireless communications network, the method comprising, while the communications device is operating in an inactive state,
receiving, from the wireless communications network, a paging message, the paging message indicating that the wireless communications network is to transmit, to the communications device, a downlink small data transmission, SDT,
determining, in response to receiving the paging message, whether or not one or more predetermined conditions for reception of the downlink SDT are met,
transmitting, to the wireless communications network, an indication of whether or not the one or more predetermined conditions are met, and
receiving the downlink SDT from the wireless communications network in a manner dependent on whether or not the one or more predetermined conditions are met.

2. A method according to claim 1, wherein the one or more predetermined conditions comprise a set of grant-free resources of the wireless radio interface having been configured for the communications device in which the communications device is able to transmit uplink SDTs to the wireless communications network and the grant-free resources being valid at the time at which the downlink SDT is to be received from the wireless communications network.

3. A method according to claim 2, wherein the grant-free resources being valid comprises an time alignment timer associated with the grant-free resources not having expired, the time alignment timer indicating a time period during which the communications device is synchronised with the wireless communications network in the uplink and/or in the downlink.

4. A method according to claim 2, comprising, if the grant-free resources are configured and valid,
transmitting a feedback signal to the wireless communications network within the grant-free resources, the feedback signal indicating that the communications device is able to receive the downlink SDT from the wireless communications network while operating in the inactive state.

5. A method according to claim 4, wherein the feedback signal is transmitted within a common control channel, CCCH message, the transmission of the CCCH message indicating that the communications device is able to receive the downlink SDT from the wireless communications network while operating in the inactive state.

6. A method according to claim 2, wherein the one or more predetermined conditions comprise a set of random access resources of the wireless radio interface having been configured for the communications device in which the communications device is able to initiate a random access procedure to transmit uplink SDTs to the wireless communications network.

7. A method according to claim 6, comprising, if the grant-free resources are not configured and/or are not valid and if the random access resources are configured,
initiating a random access procedure with the wireless communications network, wherein an uplink message of the random access procedure transmitted by the communications device to the wireless communications network comprises a feedback signal indicating that the communications device is able to receive the downlink SDT from the wireless communications network while operating in the inactive state.

8. A method according to claim 7, wherein the feedback signal is transmitted within a common control channel, CCCH message, the transmission of the CCCH message indicating that the communications device is able to receive the downlink SDT from the wireless communications network while operating in the inactive state.

9. A method according to claim 7, comprising, if the grant-free resources are not configured and/or are not valid and if the random access resources are not configured,
transmitting, to the wireless communications network, a message indicating that the one or more conditions are not met and therefore that the communications device is not able to receive the downlink SDT from the wireless communications network while operating in the inactive state.

10. A method according to claim 7, comprising, if the grant-free resources are not configured and/or are not valid and if the random access resources are not configured,
initiating a random access procedure with the wireless communications network in response to the received paging message, wherein an uplink message of the random access procedure transmitted by the communications device to the wireless communications network comprises an indication of a cause for the initiation of the random access procedure, and
receiving, from the wireless communications network in a downlink message of the random access procedure, a configuration of the communications device for the communications device to receive downlink data from the wireless communications network.

11. A method according to claim 1, wherein the one or more predetermined conditions comprise at least one data radio bearer having been configured for the communications device to receive the downlink SDT from the wireless communications network while operating in the inactive state.

12. A method according to claim 1, wherein the one or more predetermined conditions comprise a logical channel having been configured for the communications device to receive data associated with the downlink SDT from the wireless communications network while operating in the inactive state.

13. A method according to claim 1, wherein the one or more predetermined conditions comprise a radio link control, RLC, channel having been configured for the communications device to receive data associated with the downlink SDT from the wireless communications network while operating in the inactive state.

14. A method according to claim 1, wherein the one or more predetermined conditions comprise a measured quality of reference signals received by the communications device from the wireless communications network being higher than a preconfigured threshold quality required for the communications device to receive signals from the wireless communications network.

15. A method according to claim 14, wherein the preconfigured threshold quality required for the communications device to receive signals from the wireless communications network is the same as a preconfigured threshold quality required for the communications device to transmit signals to the wireless communications network.

16. A method according to claim 1, wherein the one or more predetermined conditions comprise an amount of data currently stored in a buffer of the communications device being lower than a preconfigured threshold amount.

17. A method according to claim 1, comprising, if at least one of the one or more predetermined conditions are not met,
transmitting, to the wireless communications network, a message indicating that the one or more conditions are not met and therefore that the communications device is not able to receive the downlink SDT from the wireless communications network while operating in the inactive state.

18. A method according to claim 17, comprising
initiating a random access procedure with the wireless communications network in response to the received paging message, wherein the message indicating that the one or more conditions are not met and therefore that the communications device is not able to receive the downlink SDT from the wireless communications network while operating in the inactive state is an uplink message of the random access procedure transmitted by the communications device to the wireless communications network which comprises an indication of a cause for the initiation of the random access procedure, and
receiving, from the wireless communications network in a downlink message of the random access procedure, a configuration of the communications device for the communications device to receive downlink data from the wireless communications network.

19.-25. (canceled)

26. A communications device configured to transmit signals to and/or to receive signals from a wireless communications network, the communications device comprising
transceiver circuitry configured to transmit signals and receive signals via a wireless radio interface provided by the wireless communications network, and
controller circuitry configured in combination with the transceiver circuitry, while the communications device is operating in an inactive state,
to receive, from the wireless communications network, a paging message, the paging message indicating that the wireless communications network is to transmit, to the communications device, a downlink small data transmission, SDT,
to determine, in response to receiving the paging message, whether or not one or more predetermined conditions for reception of the downlink SDT are met,
to transmit, to the wireless communications network, an indication of whether or not the one or more predetermined conditions are met, and
to receive the downlink SDT from the wireless communications network in a manner dependent on whether or not the one or more predetermined conditions are met.

27.-52. (canceled)

53. An infrastructure equipment forming part of a wireless communications network configured to transmit signals to and/or to receive signals from a communications device, the infrastructure equipment comprising
transceiver circuitry configured to transmit signals and receive signals via a wireless radio interface provided by the infrastructure equipment, and
controller circuitry configured in combination with the transceiver circuitry, while the communications device is operating in an inactive state,
to transmit, to the communications device, a paging message, the paging message indicating that the infrastructure equipment is to transmit, to the communications device, a downlink small data transmission, SDT,
to receive from the communications device, in response to transmitting the paging message, an indication of whether or not one or more predetermined conditions for reception of the downlink SDT by the communications device are met, and
to transmit the downlink SDT to the communications device in a manner dependent on whether or not the one or more predetermined conditions are met.

54.-57. (canceled)
